(19) United States
(12) Patent Application Publication
(10) Pub. No.: US 2026/0182654 A1
(43) Pub. Date: Jul. 2, 2026

(54) ELECTRONIC ATOMIZATION DEVICE, SUSCEPTOR AND METHOD

(71) Applicant: SHENZHEN FIRST UNION TECHNOLOGY CO., LTD., Shenzhen, Guangdong (CN)

(72) Inventors: Zhiyong CHEN, Shenzhen, Guangdong (CN); Ruilong HU, Shenzhen, Guangdong (CN); Yinzhe LI, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/126,050

(22) PCT Filed: Oct. 18, 2023
(86) PCT No.: PCT/CN2023/125262

§ 371 Date: Apr. 30, 2025

(30) Foreign Application Priority Data
Oct. 31, 2022 (CN) 202211352290.7

(51) Int. Cl. A24F 40/465; A24F 40/10; A24F 40/42; A24F 40/44; A24F 40/70; H05B 6/10

(52) U.S. Cl. CPC A24F 40/465; A24F 40/10; A24F 40/42; A24F 40/44; A24F 40/70; H05B 6/108

(57) ABSTRACT

An electronic atomization device, a susceptor and a method thereof are provided. The electronic atomization device includes: a liquid storage cavity, configured to store an atomizable liquid substrate; a magnetic field generator, configured to generate a varying magnetic field; and a susceptor, including a first metal material configured to be penetrable by the varying magnetic field to generate heat, to heat the liquid substrate from the liquid storage cavity to generate aerosols, a metal layer being formed on a surface of the susceptor, and the metal layer including a second metal material different from the first metal material.

### CROSS-REFERENCE TO RELATED APPLICATIONS

This application claims priority to Chinese Patent Application No. 202211352290.7, entitled “ELECTRONIC ATOMIZATION DEVICE, SUSCEPTOR AND METHOD THEREOF” and filed with the China National Intellectual Property Administration on Oct. 31, 2022, which is incorporated herein by reference in its entirety.

### TECHNICAL FIELD

This application relates to the field of electronic atomization technologies, and in particular, to an electronic atomization device, a susceptor, and a method thereof.

### BACKGROUND

An electronic atomization device is an electronic product that atomizes a liquid substrate to generate aerosols for a user to inhale, and generally includes two parts: an atomizer and a power supply assembly. The liquid substrate and an atomization core configured to atomize the liquid substrate are stored in the atomizer, and the power supply assembly includes a battery and a circuit board.

### SUMMARY

An aspect of this application provides an electronic atomization device, including:
a liquid storage cavity, configured to store an atomizable liquid substrate;
a magnetic field generator, configured to generate a varying magnetic field; and
a susceptor, including a first metal material configured to be penetrable by the varying magnetic field to generate heat, to heat the liquid substrate from the liquid storage cavity to generate aerosols, where
a metal layer is formed on a surface of the susceptor, and the metal layer includes a second metal material different from the first metal material.

Another aspect of this application provides a susceptor used in an electronic atomization device, where the susceptor includes a first metal material, where the first metal material is configured to be penetrable by a varying magnetic field to generate heat, to heat a liquid substrate to generate aerosols; and a metal layer including a second metal material different from the first metal material is formed on a surface of the susceptor, where the metal layer includes a first metal sub-layer and a second metal sub-layer sequentially formed on the surface of the susceptor, and the first metal sub-layer is combined between the second metal sub-layer and the first metal material.

Another aspect of this application further provides a method for forming a susceptor used in an electronic atomization device, where the method includes:
providing a first metal material as a base material of the susceptor;
forming a first metal sub-layer on at least a partial surface of the first metal material; and
forming a second metal sub-layer on the first metal sub-layer, to combine the first metal sub-layer between the second metal sub-layer and the first metal material.

According to the susceptor of the electronic atomization device, by forming the metal layer on the surface of the susceptor, the inhalation power consumption of the electronic atomization device is reduced; and the corrosion or oxidation of the susceptor during use can be avoided.

### BRIEF DESCRIPTION OF THE DRAWINGS

One or more embodiments are exemplarily described with reference to the corresponding figures in the accompanying drawings, and the description does not constitute a limitation to the embodiments. Elements in the accompanying drawings that have same reference numerals are represented as similar elements, and unless otherwise particularly stated, the figures in the accompanying drawings are not drawn to scale.

FIG. 1 is a schematic diagram of an electronic atomization device according to an implementation of this application;

FIG. 2 is a schematic exploded view of an electronic atomization device according to an implementation of this application;

FIG. 3 is a schematic exploded view of an atomizer according to an implementation of this application;

FIG. 4 is a schematic cross-sectional view of an atomizer according to an implementation of this application;

FIG. 5 is another schematic cross-sectional view of an atomizer according to an implementation of this application;

FIG. 6 is a schematic exploded view of an atomization core according to an implementation of this application;

FIG. 7 is a schematic sectional view of a susceptor according to an implementation of this application;

FIG. 8 is a schematic diagram of another susceptor according to an implementation of this application;

FIG. 9 is a schematic sectional view of another susceptor according to an implementation of this application;

FIG. 10 is a schematic cross-sectional view of a power supply assembly according to an implementation of this application;

FIG. 11 is a schematic diagram of a magnetic field generator according to an implementation of this application;

FIG. 12 is a schematic cross-sectional view of an electronic atomization device according to an implementation of this application;

FIG. 13 is a schematic cross-sectional view of an induction heating assembly according to an implementation of this application;

FIG. 14 is a schematic diagram of an induction heating assembly from another perspective according to an implementation of this application; and

FIG. 15 is a schematic diagram of a method for forming a susceptor according to an implementation of this application.

### DETAILED DESCRIPTION

For ease of understanding of this application, this application is described in further detail below with reference to the accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as those usually understood by a person skilled in the technical field to which this application belongs. The terms used in this specification of this application are merely intended to describe objectives of the specific implementations, and are not intended to limit this application. The term “and/or” used in this specification includes any or all combinations of one or more related listed items.

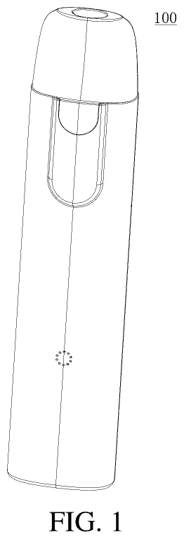

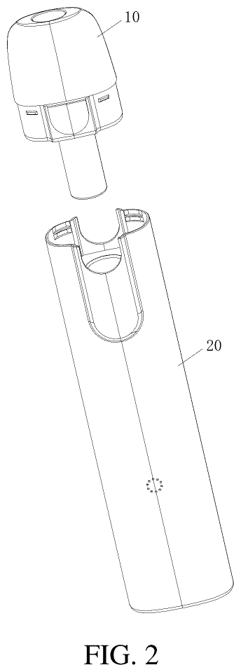

As shown in FIG. 1 and FIG. 2, an electronic atomization device 100 includes an atomizer and a power supply assembly 20.

The atomizer 10 is detachably or removably connected to the power supply assembly 20, where a connection manner includes but is not limited to a buckle connection, a magnetic connection, or a threaded connection. In another example, it is also feasible that the atomizer 10 is non-detachably connected to the power supply assembly 20.

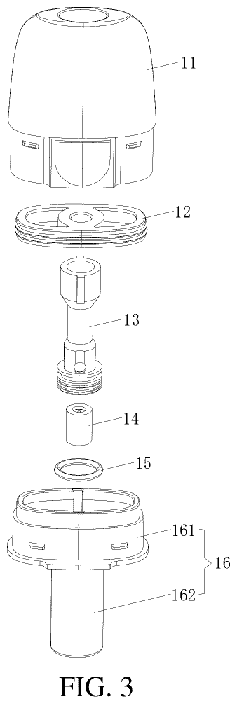

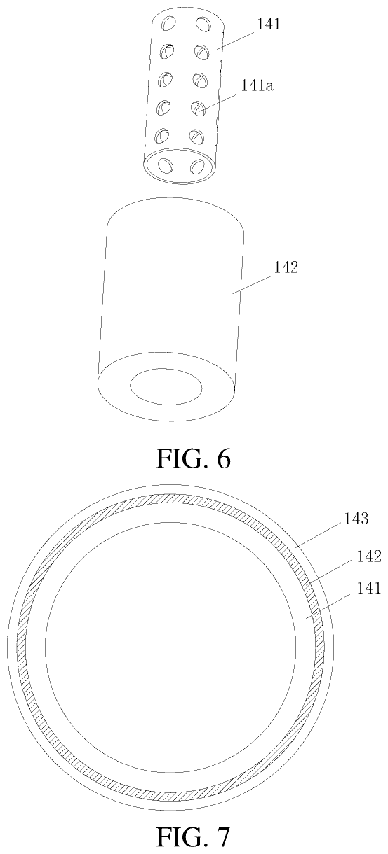

As shown in FIG. 3 to FIG. 6, the atomizer 10 includes an upper housing 11, a sealing member 12, an upper support 13, an atomization core 14, a sealing member 15, and a bottom base 16.

The upper housing 11 includes a suction nozzle end and an open end. The suction nozzle end is provided with an air outlet, and aerosols obtained through atomization may be inhaled by a user through the air outlet. The upper housing 11 further includes an integrally formed transmission tube 11a, where an inner surface of the transmission tube 11a defines a part of an airflow channel, an upper end of the transmission tube 11a is connected to the air outlet, and a lower end of the transmission tube is connected to the upper support 13.

A liquid storage cavity A is jointly defined by an inner surface of the upper housing 11 and an inner surface of the bottom base 16, and the liquid storage cavity A is configured to store a liquid substrate that may be atomized into aerosols. It can be seen from the figures that, a part of the liquid storage cavity A extends into a second connection part 162 of the bottom base 16 and surrounds a susceptor 141.

Preferably, the liquid substrate includes a tobacco-containing material, and the tobacco-containing material includes volatile tobacco flavor compounds released from the liquid substrate during heating. Alternatively or in addition, the liquid substrate may include a non-tobacco material. The liquid substrate may include water, ethanol or another solvent, plant extracts, a nicotine solution, and a natural or artificial flavoring agent. Preferably, the liquid substrate further includes an aerosol forming agent. An instance of a suitable aerosol forming agent is glycerol and propylene glycol.

The sealing member 12 is arranged between the transmission tube 11a and the upper support 13 and between the bottom base 16 and the upper housing 11, to seal a gap between the transmission tube 11a and the upper support 13 and a gap between the bottom base 16 and the upper housing 11.

The upper support 13 is kept in the bottom base 16. The upper support 13 is approximately tubular, a lower end of the upper support 13 is accommodated in the second connection part 162, and an upper end of the upper support 13 extends toward a first connection part 161 of the bottom base 16 and is connected to the transmission tube 11a. An internal hollow part of the upper support 13 defines a part of the airflow channel. An inner diameter or an outer diameter of a middle part of the upper support 13 is smaller than an inner diameter or an outer diameter of another part of the upper support.

The atomization core 14 is accommodated in the upper support 13 and is arranged close to the lower end of the upper support 13; and after assembly, the atomization core 14 is totally located in the second connection part 162 of the bottom base 16. The atomization core 14 is coaxially arranged with the upper support 13 or the second connection part 162. A liquid passing hole is provided on a side wall of the upper support 13, and the liquid substrate stored in the liquid storage cavity A may be transmitted to the atomization core 14 through the liquid passing hole.

The atomization core 14 includes the susceptor 141. The susceptor 141 is configured to be coupled to a magnetic field generator 26 and generate heat when being penetrated by a varying magnetic field, to heat the liquid substrate to generate aerosols for inhalation. The susceptor 141 may be made of a metal material, for example, aluminum, iron, nickel, copper, bronze, cobalt, ordinary carbon steel, stainless steel, ferritic stainless steel, martensite stainless steel, or austenitic stainless steel.

The susceptor 141 is constructed into a tubular susceptor surround a central axis S1. The susceptor 141 may have a cross section in a shape of an ellipse, a circle, a square, a rectangle, a triangle, or another polygon. For example, for the susceptor 141 having a circular cross section, the central axis S1 is a connecting line between a center of a top circular cross section and a center of a bottom circular cross section of the susceptor 141; and situations of other shapes are similar to that of this shape.

The susceptor 141 is axially arranged in the upper support 13 or the second connection part 162. In a preferred implementation, the central axis S1 overlaps with a central axis of the upper support 13 or the second connection part 162. An inner diameter of the susceptor 141 ranges from 0.2 mm to 20 mm, a wall thickness ranges from 0.1 mm to 2 mm, and an axial span d1 of the susceptor 141 along the central axis S1 ranges from 4 mm to 6 mm. In a specific example, the axial span d1 is 5 mm. A distance between a midpoint K1 of the axial span of the susceptor 141 along the central axis S1 and a bottom surface of the second connection part 162 is d2, and a distance between the central axis S1 and an outer surface of the second connection part 162 is d3, which are described below.

The atomization core 14 may further include a liquid transmission unit 142 to absorb the liquid substrate and transmitted the absorbed liquid substrate to the susceptor 141. The liquid transmission unit 142 has a capability of keeping liquid and may have any suitable capillary performance and porosity, for ease of usage in combination with different liquid substrate physical properties such as a density, a viscosity, surface tension, and vapor pressure. An instance of a suitable material may be ceramic, a graphite-based material, or porous metal in the form of fiber or sintered powder, for example, porous ceramic, porous glass, ceramic fiber, or metal fiber. An instance of a suitable material may alternatively be a natural or artificial fiber material, for example, natural cotton fiber, glass fiber, sponge, or non-woven fabric. For example, the liquid transmission unit 142 is made of a fiber-like material prepared by woven fiber or extruded fiber, for example, cellulose acetate, polyester fiber, adhesive polyolefin, polyethylene fiber, polypropylene fiber, or nylon fiber.

In an embodiment, the liquid transmission unit 142 is made of porous ceramic, and a material of the porous ceramic includes at least one of aluminum oxide, zirconium oxide, kaolinite, diatomite, or montmorillonite. A porosity of the porous ceramic may be adjusted within a range from 10% to 90%, and an average pore size may be adjusted within a range from 10 μm to 150 μm. In some implementations, the adjustment may be performed, for example, by an addition amount of a pore-forming agent and selection of a granularity of the pore-forming agent. The liquid transmission unit 142 is in a shape of a hollow cylinder or a tube, and the susceptor 141 matches the shape of the liquid transmission unit 142. The susceptor 141 may be arranged on an inner surface of the liquid transmission unit 142 or buried in the liquid transmission unit 142. For the hollow cylindrical liquid transmission unit 142, an inner side wall defines or forms an atomization surface of the atomization core 14, an outer side wall defines or forms a liquid absorption surface for absorbing the liquid substrate, the hollow part defines a part of an airflow channel, and aerosols obtained through atomization and air may together flow to the air outlet of the electronic atomization device 100.

In an embodiment, the susceptor 141 is constructed into a tubular structure in the shape of a closed ring or a non-closed ring, and the susceptor 141 is wound by a sheet-like metal mesh and supported on a surface of the liquid transmission unit 142.

In an embodiment, the susceptor 141 may further include a radial part radially extending from one end of the tube, and the radial part may be attached to an end portion of the liquid transmission unit 142.

In an embodiment, the susceptor 141 is buried in the liquid transmission unit 142 and is co-fired with the liquid transmission unit 142 to form the atomization core 14. In this way, the liquid substrate is not atomized only when being transmitted to be in contact with the surface of the susceptor 141, but is heated and atomized when being close to the parts of the susceptor 141. On one hand, dry burning does not occur when the susceptor 141 is in heat-conducting contact with the liquid transmission unit 142; and on the other hand, most liquid substrates are not in direct contact with the susceptor 141 during atomization, thereby avoiding metal pollution generated by the susceptor 141.

In an embodiment, the susceptor 141 may be arranged surrounding the airflow channel of the electronic atomization device 100; or the hollow part of the tubular susceptor 141 defines and forms a part of the airflow channel.

The susceptor 141 includes a plurality of through holes 141a arranged at intervals, where a hole diameter ranges from 0.1 mm to 0.5 mm, and a shape of the through hole may be a circle, an ellipse, a triangle, a diamond, another regular shape, or an irregular shape; and the aerosols may escape from the atomization surface to the airflow channel through the through holes 141a. In some examples, the through holes 141a may further increase a bonding force after the susceptor 141 and the porous ceramic are sintered, thereby improving an entire strength of the atomization core 14.

According to the schematic cross-sectional view of the susceptor 141 shown in FIG. 7, a first metal sub-layer 142 and a second metal sub-layer 143 are sequentially formed on an outer surface of the tubular susceptor 141. In a further implementation, the first metal sub-layer 142 and the second metal sub-layer 143 may alternatively be sequentially formed on an inner surface of the susceptor 141. A metal layer defined and formed by the first metal sub-layer 142 and the second metal sub-layer 143 may improve a conductivity of the susceptor 141, so that the conversion efficiency of the atomization core is further improved, and the inhalation power consumption of the electronic atomization device is reduced; and the corrosion or oxidation of the susceptor 141 during use can be avoided. The metal layer isolates the susceptor 141 from the liquid transmission unit 142 or the liquid substrate kept on the liquid transmission unit 142.

In an example, the metal layer may consecutively extend on the entire outer surface along a length direction (or a longitudinal direction) of the susceptor 141. For example, in a case that the susceptor 141 does not include the through holes 11a, the metal layer covers the whole or all outer surfaces of the susceptor 141. Certainly, for the susceptor 141 including the through holes 11a, the metal layer may be non-consecutive. For example, a mesh-shaped metal layer is also feasible. Alternatively, the metal layer may be formed on a part of an outer surface of the susceptor 141. End surfaces of upper and lower ends of the susceptor 141 are generally in contact with a keeping member (configured to keep or fix the upper and lower ends of the susceptor 141). In this case, it is also feasible to not form the metal layer.

In an example, preferably, the first metal sub-layer 142 and the second metal sub-layer 143 are metal coatings formed by using an electroplating process.

In an example, the first metal sub-layer 142 and the second metal sub-layer 143 are made of different metal materials, to improve an attaching force between the metal sub-layers. The materials of the first metal sub-layer 142 and the second metal sub-layer 143 may be different from the material of the susceptor 141. Conductivities of the first metal sub-layer 142 and the second metal sub-layer 143 are greater than the conductivity of the susceptor 141. In a preferred implementation, the first metal sub-layer 142 includes a nickel layer, and the second metal sub-layer 143 is made of at least one of materials such as gold, silver, or copper.

In an example, a thickness of the first metal sub-layer 142 ranges from 0.05 μm to 1 μm, or ranges from 0.1 μm to 1 μm; or ranges from 0.2 μm to 1 μm; or ranges from 0.4 μm to 1 μm; or ranges from 0.6 μm to 1 μm; or ranges from 0.6 μm to 0.9 μm. A thickness of the second metal sub-layer 143 ranges from 0.6 μm to 5 μm, or ranges from 1 μm to 5 μm; or ranges from 2 μm to 5 μm; or ranges from 3 μm to 5 μm.

In an example, the metal layer includes a thickness changing along the length direction of the susceptor 141. Due to different thicknesses of the metal layer, different regions or positions of the susceptor 141 may have different temperatures during use of the atomizer. For example, the thickness of the metal layer at a middle part of the susceptor 141 with more liquid substrates supplied may be large; and the thickness of the metal layer in regions close to the upper and lower ends of the susceptor 141 with few liquid substrates supplied may be small. In this way, the middle part of the susceptor 141 generates a larger amount of heat during use while heating amounts of the regions at the upper and lower ends are reduced compared with that of the middle part, which is conducive to transmitting fewer heat to the keeping member configured to keep or fix the upper and lower ends of the susceptor 141.

It should be noted that, in another example, a quantity of the metal sub-layers is not limited, and there may be three or more metal sub-layers; or there may be one metal sub-layer, for example, a metal sub-layer prepared by at least one of materials such as gold, silver, or copper is formed on the surface of the susceptor 141.

In consideration of a volume or a weight of the susceptor 141, a total thickness of the metal sub-layer preferably ranges from 0.5 μm to 10 μm.

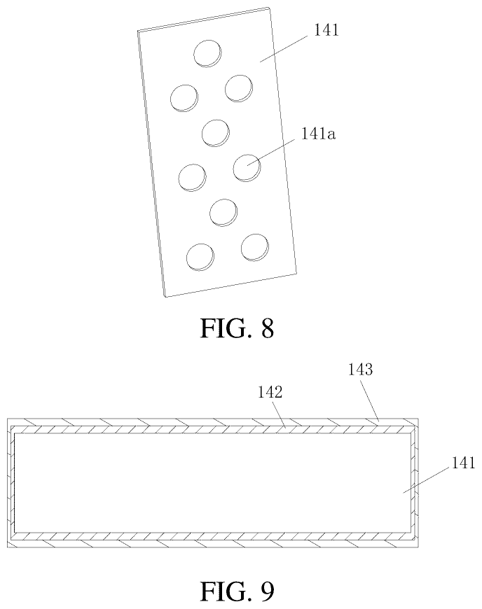

Referring to FIG. 8 and FIG. 9, this application provides another implementation example of the susceptor.

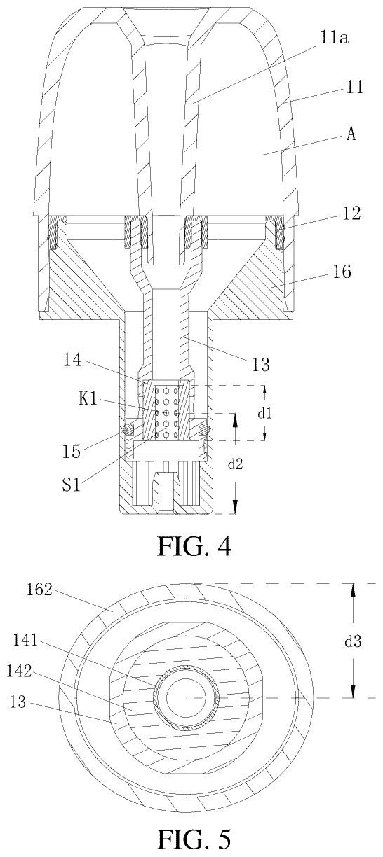

Different from the example in FIG. 4, the susceptor 141 shown in FIG. 8 is constructed into a plate-like or sheet-like structure. The plate-like or sheet-like susceptor 141 may be arranged along a direction perpendicular to a longitudinal direction of the electronic atomization device 100 or arranged along a direction parallel to a longitudinal direction of the electronic atomization device 100. Specifically, the plate-like or sheet-like susceptor 141 can be mounted in the second connection part 162 of the bottom base 16, and the susceptor 141 is arranged basically parallel 25 to the central axis of the second connection part 162. The plate-like or sheet-like susceptor 141 includes two opposite side surfaces, where one side surface is attached to the liquid transmission unit like cotton fiber, and the other side surface is exposed in the airflow channel, and a plurality of through holes 141a running through the two opposite sides are provided on the susceptor 141 to release generated aerosols into the airflow channel. In some other optional examples, a plurality of grooves or notches running through the two opposite sides of the susceptor 141 are further provided on the susceptor 141, so that the susceptor 141 is configured to include a cross section in an irregular shape, to expose a part of a surface region of the liquid transmission unit. It may be understood that, providing the through holes 141a or notches on the susceptor 141 is advantageous to reduce the weight of the susceptor and further improve a temperature rising speed. Similar to the foregoing embodiments, the metal layer may be formed on all side surfaces or some side surfaces of the plate-like or sheet-like susceptor 141. Similarly, the metal layer includes the first metal sub-layer 142 and the second metal sub-layer 143 sequentially stacked on the surface of the susceptor 141.

To verify influence of the metal layer on the inhalation power consumption of the electronic atomization device 100, for a susceptor A without a metal layer and a susceptor B obtained by electroplating a metal layer on the susceptor A having the same specification, the inventor respectively measures, under the same test conditions (for example, the same liquid substrate, the same operating frequency, the same electronic atomization device, and the same test method), corresponding inhalation power consumption of the electronic atomization device under different total particulate matter (TPM) output conditions. Measurement results are as follows:

| Serial | TPM | Inhalation power | Inhalation power |
|---|---|---|---|
| number | (mg/Puff) | consumption 1 (J/Puff) | consumption 2 (J/Puff) |
| 1 | 4 | 33 | 26 |
| 2 | 5 | 36 | 29 |
| 3 | 6 | 39 | 31 |
| 4 | 7 | 41 | 33 |
| 5 | 8 | 43 | 35 |

In the foregoing table, the inhalation power consumption 1 corresponds to the susceptor A without a metal layer, and the inhalation power consumption 2 corresponds to the susceptor B with a metal layer. It can be seen from the foregoing measurement results that, the inhalation power consumption corresponding to the susceptor B with a metal layer is significantly reduced, and a reduction amplitude ranges from 18% to 22%.

Further, the inventor places the susceptor 141 with a metal layer into a liquid substrate and observes with naked eyes after 3 to 5 days, and no corrosion or oxidation occurs on the surface of the susceptor 141.

The sealing member 15 is sleeved on the upper support 13, and the sealing member 15 is configured to seal a gap between the upper support 13 and the second connection part 162.

The bottom base 16 and the upper housing 11 forms the housing assembly of the atomizer 10. The bottom base 16 includes the first connection part 161 and the second connection part 162 that are integrally formed. The first connection part 161 is accommodated in the upper housing 11, and the second connection part 162 is exposed outside the upper housing 11 or the atomizer 10. A radial size of the first connection part 161 is greater than a radial size of the second connection part 162. A cross section of the second connection part 162 is elliptical or circular. An air inlet is provided at a bottom end of the second connection part 162, and external air flows in through the air inlet and then flows out from the air outlet of the upper housing 11 after passing through the atomization core 14, the upper support 13, and the transmission tube 11a sequentially.

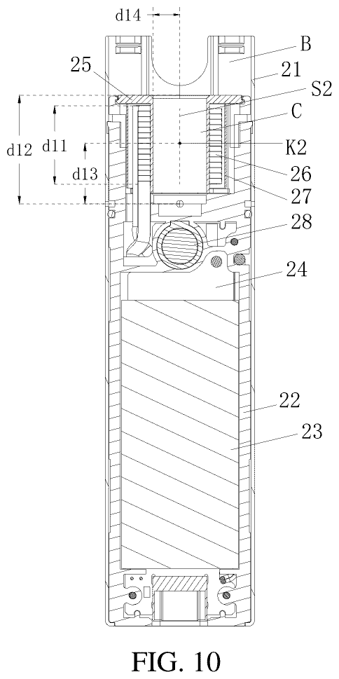

As shown in FIG. 10, the power supply assembly 20 includes a lower housing 21, a lower support 22, a battery core 23, a circuit 24, a base 25, a magnetic field generator 26, a shielding member 27, and a sensor 28.

The lower housing 21 is a columnar structure having openings at two ends. The lower housing 21 and the upper housing 11 define and form an outer housing of the electronic atomization device 100. An airflow inlet is provided on an outer surface of the lower housing 21, and external air flows into the lower housing 21 through the airflow inlet. A part of an outer surface of each of front and rear surfaces of the lower housing 21 protrudes outward to increase a size of a part of the power supply assembly 20 in a thickness direction, so that a magnetic field generator 26 with a large size may be accommodated.

The lower support 22 is accommodated in the lower housing 21, and the battery core 23, the circuit 24, the base 25, the magnetic field generator 26, the shielding member 27, and the sensor 28 are all arranged on the lower support 22. A size of the lower support 22 in the length direction is smaller a size of the lower housing 21 in the length direction. A receiving cavity B is defined and formed between an upper end of the lower support 22 and an upper end of the lower housing 21 or between the lower support 22 and an inner surface of the lower housing 21, and a lower end of the lower support 22 abuts against an end portion of a lower end of the lower housing 21; and after assembly, a part of the upper housing 11 is received in the receiving cavity B.

The battery core 23 provides power for operating the electronic atomization device 100. The battery core 23 may be a rechargeable battery core or a disposable battery core.

The circuit 24 may control overall operations of the electronic atomization device 100. The circuit 24 not only controls operations of the battery core 23 and the magnetic field generator 26, but also controls operations of other elements in the electronic atomization device 100. The circuit 24 includes at least one processor. The processor may include a logic gate array, or may include a combination of a general microprocessor and a memory storing programs executable in the microprocessor. In addition, a person skilled in the art should understand that the circuit 24 may include another type of hardware.

The base 25 is approximately tubular, and a hollow part inside the base defines or forms at least a part of a receiving cavity C. after assembly, the second connection part 162 of the bottom base 16 is at least partially received in the receiving cavity C. When the second connection part 162 of the bottom base 16 is received in the receiving cavity C, the first connection part 161 remains in contact with the base 25, and a bottom surface of the second connection part 162 remains in contact with a bottom wall of the receiving cavity C or a gap therebetween is quite small and can be ignored.

The magnetic field generator 26 generates a varying magnetic field at an alternating current, and the battery core 23 provides a high-frequency oscillating current to the magnetic field generator 26. A frequency of the alternating current supplied to the magnetic field generator 26 ranges from 500 KHz to 3 MHz. Preferably, the frequency may range from 500 KHz to 2.5 MHz. Further preferably, the frequency may range from 500 KHz to 2 MHz. Further preferably, the frequency may range from 500 KHz to 1.5 MHz. Further preferably, the frequency may range from 500 KHz to 1 MHz.

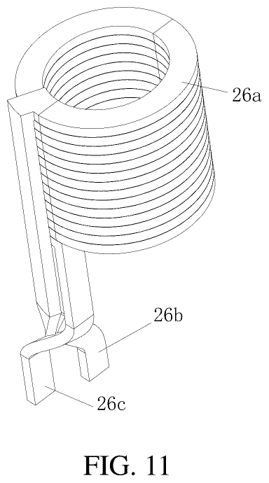

As shown in FIG. 11, a main body part 26a of the magnetic field generator 26 is constructed into a tubular induction coil spirally wound around a central axis S2. The main body part 26a is sleeved on or surrounds a periphery of the base 25, that is, is arranged around the receiving cavity C in a circumferential or surrounding manner. The main body part 26a may have a cross section in a shape of an ellipse, a circle, a square, a rectangle, a triangle, or another polygon. For example, for the main body part 26a having a circular cross section, the central axis S2 is a connecting line between a center of a top circular cross section and a center of a bottom circular cross section of the main body part 26a; and situations of other shapes are similar to that of this shape. An electrical connection portion 26b and an electrical connection portion 26c of the magnetic field generator 26 are configured to be electrically connected to the battery core 23.

The main body part 26a is made by winding a long wire material, for example, winding 500 to 2000 wires, 500 to 1900 wires, 700 to 1900 wires, 900 to 1900 wires, 1000 to 1900 wires, 1200 to 1900 wires, 1400 to 1900 wires, or 1600 to 1900 wires. A cross section of the wire material may be in a shape of a rectangle, a circle, or an ellipse.

A quantity of turns or windings of the main body part 26a ranges from 4 to 20; preferably, ranges from 6 to 20; further preferably, ranges from 6 to 15; further preferably, ranges from 6 to 12; and further preferably, ranges from 6 to 10. A gap between adjacent turns or windings approximately ranges from 0.1 mm to 0.5 mm. In a specific embodiment, the gap between adjacent turns or windings is 0.2 mm or 0.4 mm.

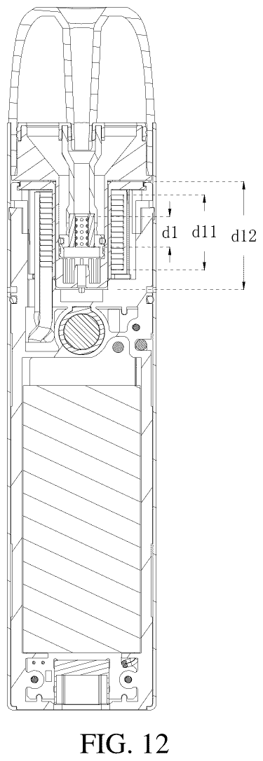

Based on factors such as a design of the susceptor 141 or an overall design of the electronic atomization device 100, the axial span d1 of the susceptor 141 along the central axis S1 is generally one third or lower (approximately ranging from one fourth to one third) of an axial span of the second connection part 162. To enable the susceptor 141 to be totally placed in the magnetic field generator 26 when the second connection part 162 of the bottom base 16 is received in the receiving cavity C, an axial span d11 of the magnetic field generator 26 along the central axis S2 is greater than the axial span d1 of the susceptor 141 along the central axis S1, and the axial span d11 of the magnetic field generator 26 along the central axis S2 is two thirds or higher of an axial span d12 of the receiving cavity C along the central axis S2, where a maximum value of d11 may be equal to d12. In this way, the susceptor 141 can be totally placed in the magnetic field generator 26, and coupling of an alternating magnetic field generated by the magnetic field generator 26 to the susceptor 141 is significantly increased. FIG. 12 shows a case that the susceptor 141 is totally placed in the magnetic field generator 26. That the susceptor 141 is totally placed in the magnetic field generator 26 means that the upper and lower ends of the susceptor 141 and the upper end lower ends of the magnetic field generator 26 are correspondingly spaced apart.

In an example, the axial span d11 of the magnetic field generator 26 along the central axis S2 may be twice or higher of the axial span d1 of the susceptor 141 along the central axis S1. Preferably, d11 is 2 to 3 times of d1.

In an example, the axial span d11 of the magnetic field generator 26 along the central axis S2 ranges from 10 mm to 15 mm; preferably, ranges from 10 mm to 14 mm; further preferably, ranges from 10 mm to 13 mm; and further preferably, ranges from 11 mm to 13 mm.

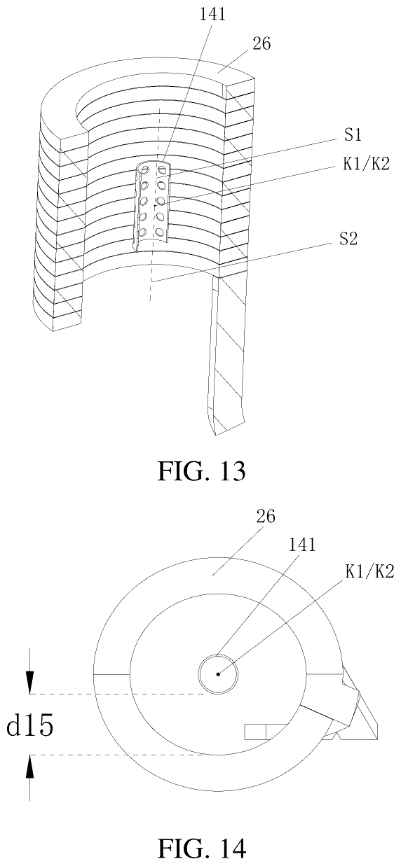

In a further implementation, an offset distance between the central axis of S1 of the susceptor 141 and the central axis S2 of the magnetic field generator 26 ranges from 0 mm to 3 mm (including end values). An offset distance between the midpoint K1 of the axial span of the susceptor 141 along the central axis S1 and a midpoint K2 of the axial span of the magnetic field generator 26 along the central axis S2 ranges from 0 mm to 3 mm (including end values). When the offset distance between the central axis S1 of the susceptor 141 and the central axis S2 of the magnetic field generator 26 is 0 mm, it means that the central axis S1 overlaps with the central axis S2; and when the distance between the midpoint K1 of the axial span of the susceptor 141 along the central axis S1 and the midpoint K2 of the axial span of the magnetic field generator 26 along the central axis S2 is 0 mm, it means that a center of the susceptor 141 overlaps with a center of the magnetic field generator 26 or centers of the susceptor and the magnetic field generator along the axial direction overlap with each other. FIG. 13 and FIG. 14 shows cases that both the central axes and the centers overlap with each other.

This is advantageous since the alternating magnetic field generated by the magnetic field generator 26 is strongest at the center and is weaker at two ends. Therefore, when the central axis S1 overlaps with the central axis S2 and the center of the susceptor 141 overlaps with the center of the magnetic field generator 26, it means that coupling of the alternating magnetic field generated by the magnetic field generator 26 to the susceptor 141 is optimal, and the conversion efficiency of an induction heating assembly formed by the magnetic field generator 26 and the susceptor 141 is optimal.

The inventor tests the distance (corresponding to D2 in the following table) between the central axis S1 and the central axis S2 and the distance (corresponding to D1 in the following table) between the midpoint K1 of the axial span of the susceptor 141 along the central axis S1 and the midpoint K2 of the axial span of the magnetic field generator 26 along the central axis S2, and test results are as follows:

| Serial number | D1 | D2 | Conversion efficiency |
|---|---|---|---|
| 1 | 0 | 0 | 85.34% |
| 2 | 1 mm | 0 | 74.58% |
| 3 | 2 mm | 0 | 63.26% |
| 4 | 3 mm | 0 | 51.24% |
| 5 | 0 | 1 mm | 72.56% |
| 6 | 0 | 2 mm | 59.76% |
| 7 | 0 | 3 mm | 46.59% |

It can be verified from the foregoing test results that, when the central axis S1 overlaps with the central axis S2 and the center of the susceptor 141 overlaps with the center of the magnetic field generator 26, the conversion efficiency of the induction heating assembly is optimal and is about 85.34%; and when the distance between the central axis S1 and the central axis S2 increases and the distance between the midpoint K1 of the axial span of the susceptor 141 along the central axis S1 and the midpoint K2 of the axial span of the magnetic field generator 26 along the central axis S2 increases, the conversion efficiency of the induction heating assembly is in a descending trend. Compared with a distance change between the midpoint K1 of the axial span of the susceptor 141 along the central axis S1 and the midpoint K2 of the axial span of the magnetic field generator 26 along the central axis S2, a distance change between the central axis S1 and the central axis S2 has larger influence on the conversion efficiency of the induction heating assembly.

The distance between the midpoint K1 of the axial span of the susceptor 141 along the central axis S1 and the bottom surface of the second connection part 162 is d2, a distance between the midpoint K2 of the axial span of the magnetic field generator 26 along the central axis S2 and a bottom wall of the receiving cavity C is d13, and a difference between d2 and d13 ranges from 0 mm to 3 mm. The distance between the central axis S1 and the outer surface of the second connection part 162 is d3, a distance between the central axis S2 and an inner wall of the receiving cavity C is d14, and a difference between d3 and d14 ranges from 0 mm to 3 mm.

In a further implementation, a minimum radial distance d15 between the magnetic field generator 26 and the susceptor 141 ranges from 3 mm to 7 mm; preferably, ranges from 3 mm to 6 mm; and further preferably, ranges from 4 mm to 6 mm. Coupling of the alternating magnetic field generated by the magnetic field generator 26 to the susceptor 141 is ensured.

It should be noted that, in another example, the magnetic field generator 26 may alternatively be constructed into a planar spiral coil. The planar spiral coil may be arranged along a direction perpendicular to the longitudinal direction of the electronic atomization device 100 or arranged along the longitudinal direction of the electronic atomization device 100. The planar spiral coil may be supported by a sheet-like or plate-like support member or may be embedded into another component.

The shielding member 27 is arranged or sleeved outside the magnetic field generator 26 in a surrounding manner. The shielding member 27 is configured to shield the magnetic field approximately emanated by the magnetic field generator 26 along a radial direction, to prevent the emanated magnetic field from affecting other components.

The sensor 28 senses an airflow change in the lower housing 21 through a sensing channel, that is, detects inhalation by a user, to generate a signal to control the atomizer 10 to starts working.

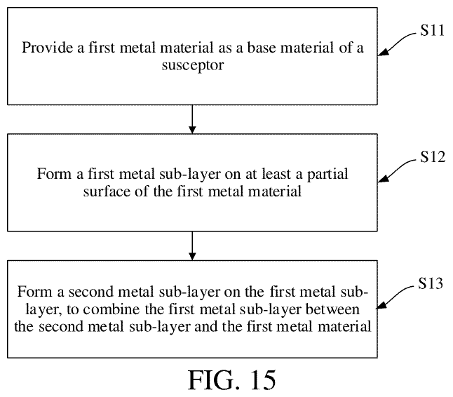

FIG. 15 is a schematic diagram of a method for forming a susceptor according to an implementation of this application.

As shown in FIG. 15, the method includes:
Step S11. Providing a first metal material as a base material of the susceptor.
Step S12. Forming a first metal sub-layer on at least a partial surface of the first metal material.
Step S13. Forming a second metal sub-layer on the first metal sub-layer, to combine the first metal sub-layer between the second metal sub-layer and the first metal material.

In an example, the first metal sub-layer and the second metal sub-layer covers the whole outer surface and/or inner surface of the susceptor.

In an example, the first metal sub-layer includes a nickel layer, and the second metal sub-layer is made of at least one of materials such as gold, silver, or copper.

In an example, a thickness of the first metal sub-layer ranges from 0.05 μm to 1 μm, or ranges from 0.1 μm to 1 μm; or ranges from 0.2 μm to 1 μm; or ranges from 0.4 μm to 1 μm; or ranges from 0.6 μm to 1 μm; or ranges from 0.6 μm to 0.9 μm. A thickness of the second metal sub-layer ranges from 0.6 μm to 5 μm, or ranges from 1 μm to 5 μm; or ranges from 2 μm to 5 μm; or ranges from 3 μm to 5 μm.

In an example, the first metal sub-layer and the second metal sub-layer are metal coatings formed by using an electroplating process.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of the specification of this application. Further, a person of ordinary skill in the art may make improvements or modifications according to the foregoing description, and all the improvements and modifications shall fall within the protection scope of the appended claims of this application.

1. An electronic atomization device, comprising:
a liquid storage cavity, configured to store an atomizable liquid substrate;
a magnetic field generator, configured to be capable of generating a varying magnetic field; and
a susceptor, comprising a first metal material configured to be penetrable by the varying magnetic field to generate heat, to heat the liquid substrate from the liquid storage cavity to generate aerosols,
wherein a metal layer is formed on a surface of the susceptor, and the metal layer comprises a second metal material different from the first metal material.

2. The electronic atomization device according to claim 1, wherein a conductivity of the second metal material is greater than a conductivity of the first metal material.

3. The electronic atomization device according to claim 1, wherein the metal layer comprises a metal coating formed on the surface of the susceptor.

4. The electronic atomization device according to claim 1, wherein the metal layer comprises a thickness changing along a length direction of the susceptor.

5. The electronic atomization device according to claim 1, wherein a total thickness of the metal layer ranges from 0.5 μm to 10 μm.

6. The electronic atomization device according to claim 1, wherein the metal layer comprises a plurality of metal sub-layers formed on the surface of the susceptor.

7. The electronic atomization device according to claim 6, wherein adjacent metal sub-layers are made of different materials.

8. The electronic atomization device according to claim 6, wherein the metal layer comprises a first metal sub-layer and a second metal sub-layer sequentially formed on the surface of the susceptor, and the first metal sub-layer is combined between the second metal sub-layer and the first metal material.

9. The electronic atomization device according to claim 8, wherein the first metal sub-layer comprises a nickel layer, and the second metal sub-layer is made of at least one of materials such as gold, silver, or copper.

10. The electronic atomization device according to claim 8, wherein a thickness of the first metal sub-layer ranges from 0.05 μm to 1 μm, and a thickness of the second metal sub-layer ranges from 0.6 μm to 5 μm.

11. The electronic atomization device according to claim 1, wherein the metal layer covers all surfaces of the susceptor.

12. The electronic atomization device according to claim 1, wherein the susceptor is constructed into a tubular, plate-like, or sheet-like structure.

13. The electronic atomization device according to claim 1, further comprising a liquid transmission unit, configured to transmit the liquid substrate to the susceptor, wherein
the susceptor is arranged on a surface of the liquid transmission unit or at least partially buried in the liquid transmission unit.

14. The electronic atomization device according to claim 13, wherein the liquid transmission unit is arranged to be in contact with the surface of the susceptor, and the metal layer is configured to isolate the first metal material from the liquid transmission unit or the liquid substrate kept on the liquid transmission unit.

15. The electronic atomization device according to claim 1, wherein the magnetic field generator comprises an induction coil, and an operating frequency provided to the induction coil ranges from 100 KHz to 3 MHz.

16. A susceptor used in an electronic atomization device, wherein the susceptor comprises a first metal material, wherein the first metal material is configured to be penetrable by a varying magnetic field to generate heat, to heat a liquid substrate to generate aerosols; and a metal layer comprising a second metal material different from the first metal material is formed on a surface of the susceptor, wherein the metal layer comprises a first metal sub-layer and a second metal sub-layer sequentially formed on the surface of the susceptor, and the first metal sub-layer is combined between the second metal sub-layer and the first metal material.

17. A method for forming a susceptor used in an electronic atomization device, wherein the method comprises:
providing a first metal material as a base material of the susceptor;
forming a first metal sub-layer on at least a partial surface of the first metal material; and
forming a second metal sub-layer on the first metal sub-layer, to combine the first metal sub-layer between the second metal sub-layer and the first metal material.
